(19) United States
(12) Patent Application Publication
(10) Pub. No.: US 2025/0123504 A1
(43) Pub. Date: Apr. 17, 2025

(54) POLARIZATION-MODE CONTROLLED NONRECIPROCAL OPTICAL WAVEGUIDE DEVICE AND OPTICAL ISOLATOR/OPTICAL CIRCULATOR USING THEREOF

(71) Applicant: PhotoniSol Inc., Incheon (KR)

(72) Inventors: Kyong Hon KIM, Incheon (KR); Seung Hwan KIM, Incheon (KR); Beom Su PARK, Incheon (KR)

(21) Appl. No.: 18/907,476

(22) Filed: Oct. 5, 2024

(30) Foreign Application Priority Data
Oct. 11, 2023 (KR) 10-2023-0134874

(51) Int. Cl. G02F 1/01; G02F 1/095

(52) U.S. Cl. CPC G02F 1/0142; G02F 1/0955

(57) ABSTRACT

Provided are polarization-mode controlled nonreciprocal optical waveguide devices, which are used in optical isolator and optical circulator devices. These devices offer a solution to the issues associated with traditional planar optical waveguide-based optical isolators, which are specific to a single polarization mode and result in significant optical loss. The new devices implement polarization-insensitive operation with minimal optical loss. They feature a magneto-optic (MO) film clad on one side and utilize waveguide mode converters or polarization-mode converters to guide the input light signals' mode or polarization. This reduces optical loss as the light passes through the interface between the non-MO clad region and the MO clad region and maximizes the MO effect within the MO clad region by ensuring proper polarization mode.

### CROSS-REFERENCE TO RELATED APPLICATIONS

This application claims the benefit and priority of Korean Patent Application No. 10-2023-0134874, filed with the Korean Intellectual Property Office on Oct. 11, 2023, the disclosure of which is incorporated herein by reference in its entirety.

### BACKGROUND

### 1. Technical Field

The present invention discloses polarization-mode controlled nonreciprocal optical waveguide devices and their applications in optical isolator and optical circulator devices. This addresses the limitations of traditional planar optical waveguide-based optical isolators, which are designed for a specific polarization mode and suffer from high optical loss. This invention offers polarization-insensitive operation with minimal optical loss by using a magneto-optic (MO) film clad on one side with waveguide mode converter(s) or/and polarization-mode converter(s). The converter(s) is(are) used for mode conversion of the input light signals' guiding mode or polarization mode to reduce optical loss as the beam passes through the interface between the non-MO clad region and the MO clad region and to maximize the MO effect within the MO clad region by ensuring the proper polarization mode.

### 2. Description of the Related Art

In recent times, there has been a growing demand for photonic integrated module and circuit technologies. These are needed for applications in large-capacity optical transceiver modules in data centers, as well as for optical interposers and interconnects to manage signal I/O processes between electronic chips in the face of increasing data and information processing needs. One of the crucial components for these photonic integrated modules and circuits is the integrated optical isolator chip. There are two main approaches being developed for optical isolator chips: one involves polarization mode conversion, while the other utilizes phase shift, based on the Faraday effect in magneto-optic thin films.

The development of optical isolator chips involves two main approaches: one using nonreciprocal polarization-mode conversion (NRPMV) and the other using nonreciprocal phase shift (NRPS), both based on the magneto-optic effect. Initially, optical isolator schemes utilized optical waveguides made of the magneto-optic film itself, however, this approach faced limitations due to the incompatible integration with other devices. Recently, silicon photonics technology has emerged as a promising alternative due to its compatibility with conventional electronic devices and potential for development into photonic integrated circuits. As a result, optical isolator technologies using silicon optical waveguides and magneto-optic clad layers are being pursued. For instance, magneto-optic films coated on crystallized substrates have been bonded on top of silicon optical waveguides to demonstrate optical isolator chips. However, this method is not suitable for mass production and is associated with high optical loss. Additionally, optical isolator chips using directly coated and crystallized magneto-optic film on silicon optical waveguides have been reported, but their optical loss properties still need improvement.

Patents U.S. Pat. Nos. 6,943,932, 7,043,100 discuss the demonstration of optical isolator chips that utilize the magneto-optic phase shift in Mach-Zehnder-type optical waveguides made from magneto-optic materials. These chips are designed for TE and TM polarization-mode operations with magnetic fields applied along the horizontal and vertical directions, respectively. However, these chips have a drawback as they are not suitable for integration with other devices. Another prior art, U.S. Pat. No. 7,260,282, describes optical isolator chip structures composed of nonreciprocal 45-degree polarization rotator and reciprocal 45-degree polarization rotator between a pair of optical waveguide-type polarizers. However, these isolator chip structures use special semiconductor materials and do not provide any technical descriptions about the optical losses at the interfaces of their components.

In some existing technologies, nonreciprocal phase shifters or polarization rotators have been implemented by using a magneto-optical thin film bonded on top of a planar optical waveguide. However, a significant drawback of this approach is the light loss caused by the bonding structure of the magneto-optical thin film.

### PATENT DOCUMENT

Korean registered patent 10-1550502 (2015.09.04 published) “INTEGRATABLE PLANAR WAVEGUIDE-TYPE OPTICAL ISOLATOR AND CIRCULATOR WITH POLARIZATION-MODE CONTROL”

The previous <Patent document> has described optical isolator and circulator chip structures using polarization mode control based on silicon optical waveguides. However, there is a growing need for new structures that can more effectively reduce optical loss.

### SUMMARY OF THE INVENTION

The present invention was created to address the aforementioned issues.

The purpose of the present invention is to solve the limitations of current planar optical waveguide-based optical isolator devices. These conventional devices are restricted to operating only for optical input signals of a specific polarization mode and suffer from significant optical loss. The goal is to reduce optical loss and enable operation regardless of the polarization mode of the optical signal. The invention aims to provide a polarization-mode controlled nonreciprocal optical waveguide device, as well as an optical isolator and optical circulator device using the same.

Another purpose of the present invention is to provide a polarization-mode controlled nonreciprocal optical waveguide device that utilizes a mode converter or a polarization converter to minimize optical signal loss when passing through the interface between magneto-optic (MO) film clad coated and uncoated optical waveguides. This device is designed to ensure that the optical signals experience the maximum MO effect and can be integrated to form an optical isolator and optical circulator device.

The present invention is implemented in exemplary embodiments with the following configurations to achieve the above-described purpose.

In one embodiment of the present invention, a polarization-mode controlled nonreciprocal optical waveguide device is provided. The device includes an optical waveguide made of relatively high refractive index material to guide optical signals, cladding layers surrounding the optical waveguide, with one side of the cladding layer of the optical waveguide composed of a magneto-optic film of relatively lower refractive index. The device also includes a waveguide-mode converter to set the polarization mode of optical signals for low optical loss in the magneto-optic (MO) cladding waveguide region before entering from the non-MO-cladding waveguide region. Additionally, a polarization-mode converter is included to set the polarization mode of the optical signal entered in the MO-clad waveguide region and placed in the input side of the MO-clad region for the maximum MO effect generation. Another polarization-mode converter is placed at the output side of the MO-clad region to set the polarization mode of the optical signal for low optical loss at the interface between the MO-clad and the non-MO-clad regions.

In another embodiment of the present invention, if the optical waveguide mentioned above has MO-clad on top of the waveguide with low thickness, which causes high optical loss during the polarization-mode conversion process, the waveguide-mode converter will convert the TE0 or TM0 mode of the input optical signal into the TE1 mode. The polarization-mode converter in the input MO-clad region will then convert the TE1 mode into TM0 mode, and the polarization-mode converter in the output MO-clad region will convert the TM0 mode back into TE1 mode.

According to another embodiment of the present invention, when the optical waveguide mentioned above has a magneto-optical cladding (MO-clad) on top of the waveguide with sufficient thickness to minimize optical propagation loss, the waveguide-mode converter is illuminated for a TE0 input optical signal beam. In this case, the input-side polarization-mode converter converts the TE0 mode into the TM0 mode, and the output-side polarization-mode converter converts the TM0 mode back into the TE0 mode.

According to another embodiment of the present invention, the above-mentioned optical waveguide device includes a secondary waveguide-mode converter. This converter changes the optical signal that has passed through the output-side polarization-mode converter and the MO-clad waveguide region into the waveguide mode of the original input optical signal.

In another version of the present invention, an optical isolator utilizes a polarization-mode controlled nonreciprocal optical waveguide device. This device includes one of the four types mentioned, with a magnetic field applied to the magneto-optical (MO) cladding in a direction orthogonal to the optical beam propagation. The device is positioned in one arm of two arms formed by a pair of 2×2 or 1×2 directional couplers. A reciprocal phase shifter is positioned in the other arm.

In another embodiment of the present invention, planar-waveguide-type optical isolator and circulator devices consist of a polarization-mode controlled nonreciprocal optical waveguide device from the four types mentioned above. A magnetic field is applied to the magneto-optic (MO) clad in the parallel direction to the optical beam propagation. This device is placed at one arm of two arms formed by a pair of 2×2 or 1×2 directional couplers, and it functions as a nonreciprocal 45-degree polarization rotator with a reciprocal 45-degree polarization, along with the non-connected secondary arm.

In another version of the current invention, polarization-independent planar-waveguide-type optical isolator and circulator devices consist of a polarization-mode controlled nonreciprocal optical waveguide device. This device is one of the four types mentioned above and is used for the TE0-mode input optical beam. A magnetic field is applied to the MO clad in the parallel direction to the optical beam propagation. This device is placed at one arm of the two arms formed by a pair of 2×2 or 1×2 directional couplers to function as a nonreciprocal 45-degree polarization rotator connected with a reciprocal 45-degree polarization in series. Another polarization-mode controlled nonreciprocal optical waveguide device is used for the TM0-mode optical beam and serves as a nonreciprocal 45-degree polarization rotator connected with a reciprocal 45-degree polarization in series.

In another version of the present invention, planar-waveguide-type optical isolator and circulator devices include one polarization-mode controlled nonreciprocal optical waveguide device from the four types mentioned above. This device has a magnetic field applied to the magneto-optical (MO) clad in a direction orthogonal to the optical beam propagation. The device is placed on the circumference of a micro-ring-type waveguide, with a section of the micro-ring waveguide having a clad layer that undergoes refractive index changes when exposed to laser or ultraviolet beam illumination. Additionally, there is a linear-type optical waveguide coupled with this micro-ring waveguide.

According to another embodiment of the present invention, a planar waveguide type micro-ring optical isolator device consists of two or more micro-ring waveguides coupled in series to enlarge the linewidth of the resonant filtering wavelength.

In another version of the current invention, a planar waveguide type polarization-independent micro-ring optical isolator device is made up of a planar waveguide type micro-ring optical isolator device. It contains polarization-mode controlled nonreciprocal optical waveguide devices among the four types mentioned. A magnetic field is applied to the MO clad in the orthogonal direction with respect to the optical beam propagation on the circumference of a micro-ring-type waveguide. This is coupled with a linear-type optical waveguide for the TE0 mode input. Another planar waveguide type micro-ring optical isolator device has a similar configuration but for the TM0 mode input. Each of these two planar waveguide type micro-ring optical isolator devices is placed on each of two arms formed by a pair of 2×2 polarization beam splitters.

In another version of the present invention, a planar-waveguide-type micro-ring optical isolator device is comprised of a pair of polarization-mode controlled nonreciprocal optical waveguide devices from the four mentioned types. These are used for input beam polarization modes of TE0 and TM0, and are coupled with a linear-type optical waveguide in series.

The present invention provides the following effects through the configuration, combination, and use of the embodiment described above according to the description to be explained.

The present invention offers low optical loss and polarization-independent operation by eliminating the drawbacks of polarization-dependent operation and large optical loss in the conventional planar-waveguide-type optical isolator device.

The current invention aims to provide a polarization-mode controlled non-reciprocal optical waveguide device structure that can be easily integrated into existing semiconductor processes. It can also be seamlessly integrated with semiconductor electronic integrated circuits as well as other silicon optical waveguide devices, with minimal optical loss.

The optical isolator and optical circulator device described in this invention can serve as a photonic integrated device needed for high-capacity optical transceiver modules in data centers and optical communications. Additionally, it can be utilized in optical interposers and interconnects for high-capacity signal transmission between electronic chips. This invention is crucial for next-generation semiconductors and the development of high-capacity computers.

### BRIEF DESCRIPTION OF THE DRAWINGS

FIGS. 1A-1F are reference diagrams showing several examples of a polarization-mode controlled nonreciprocal optical waveguide device according to an embodiment of the present invention.

FIGS. 2A-2B represent graphs showing the calculated results of the effective refractive indices of the waveguide modes versus the optical waveguide width. The height of the silicon optical waveguide surrounded by silica clad is 220 nm and 300 nm, respectively.

FIG. 3 is a reference diagram illustrating a nonreciprocal phase-shift optical isolator structure based on a low-height (core) optical waveguide for a TE0 polarization input optical signal, according to another embodiment of the present invention.

FIG. 4 is a reference diagram illustrating a nonreciprocal phase-shift optical isolator structure based on a low-height (core) optical waveguide for a TM0 polarization input optical signal according to another embodiment of the present invention.

FIG. 5 is a reference diagram illustrating a nonreciprocal phase-shift optical isolator structure based on a high-height (core) optical waveguide for a TM0 polarization input optical signal according to another embodiment of the present invention.

FIG. 6 is a reference diagram illustrating a nonreciprocal phase-shift optical isolator structure based on a high-height (core) optical waveguide for a TE0 polarization input optical signal according to another embodiment of the present invention.

FIG. 7 is a reference diagram illustrating a nonreciprocal polarization-rotation optical isolator and circulator structure based on a high-height (core) optical waveguide for a TM0 polarization input optical signal according to another embodiment of the present invention.

FIG. 8 is a reference diagram illustrating a nonreciprocal polarization-rotation optical isolator and circulator structure based on a high-height (core) optical waveguide for a TE0 polarization input optical signal according to another embodiment of the present invention.

FIG. 9 is a reference diagram illustrating a nonreciprocal polarization-rotation optical isolator and circulator structure based on a high-height (core) optical waveguide for a polarization-independent optical signal input according to another embodiment of the present invention.

FIGS. 10A-10C are reference diagrams illustrating a ring-type optical isolator structure based on a low-height (core) optical waveguide for TE0 polarization input optical signal according to another embodiment of the present invention.

FIGS. 11A-11C are reference diagrams illustrating a ring-type optical isolator structure based on a low-height (core) optical waveguide for TM0 polarization input optical signal according to another embodiment of the present invention.

FIGS. 12A-12C are reference diagrams illustrating a ring-type optical isolator structure based on a high-height (core) optical waveguide for TE0 polarization input optical signal according to another embodiment of the present invention.

FIGS. 13A-13C are reference diagrams illustrating a ring-type optical isolator structure based on a high-height (core) optical waveguide for TM0 polarization input optical signal according to another embodiment of the present invention.

FIGS. 14A-14C are reference diagrams illustrating a ring-type optical isolator structure based on a high-height (core) optical waveguide for TM0 polarization input optical signal according to another embodiment of the present invention.

FIG. 15 is a reference diagram illustrating an optical isolator structure for a TE0 fundamental polarization-mode incident optical signal, where two ring-shaped optical isolator structures from FIGS. 12A-12C are connected in series.

FIG. 16 is a reference diagram illustrating an optical isolator structure for a TM0 fundamental polarization-mode incident optical signal, where two ring-shaped optical isolator structures from FIGS. 12A-12C are connected in series.

FIG. 17 is a reference diagram showing a ring-type optical isolator structure utilizing the configurations of FIGS. 12A-12C and FIG. 3.

FIG. 18 is a reference diagram depicting an optical isolator structure where two of the ring-shaped optical isolator structures of FIGS. 12A-12C and FIGS. 13A-13C are connected in series.

### DETAILED OF THE INVENTION

The following text serves as a detailed description of the present invention, along with accompanying drawings. The drawings depict exemplary embodiments of a polarization-controlled nonreciprocal optical waveguide device, as well as optical isolator and optical circulator devices utilizing it. It is important to note that consistent notations are employed to represent the same components throughout the drawings. Unless specifically defined otherwise, all terms in this specification carry their common meanings understood by those involved in this subject. When a part “includes” a certain component, this indicates that it may encompass other components as well, unless explicitly stated otherwise.

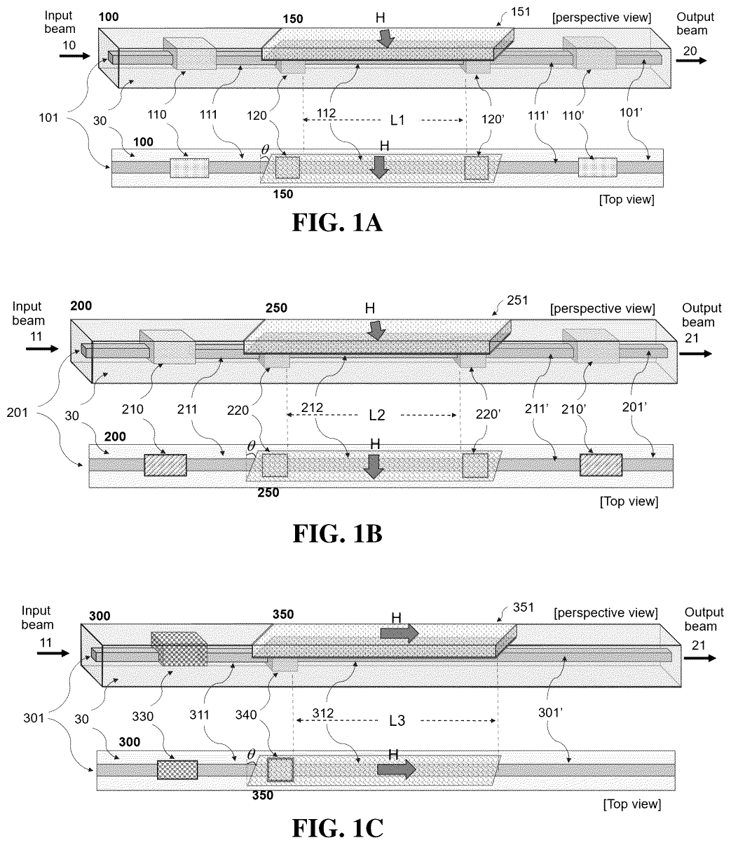

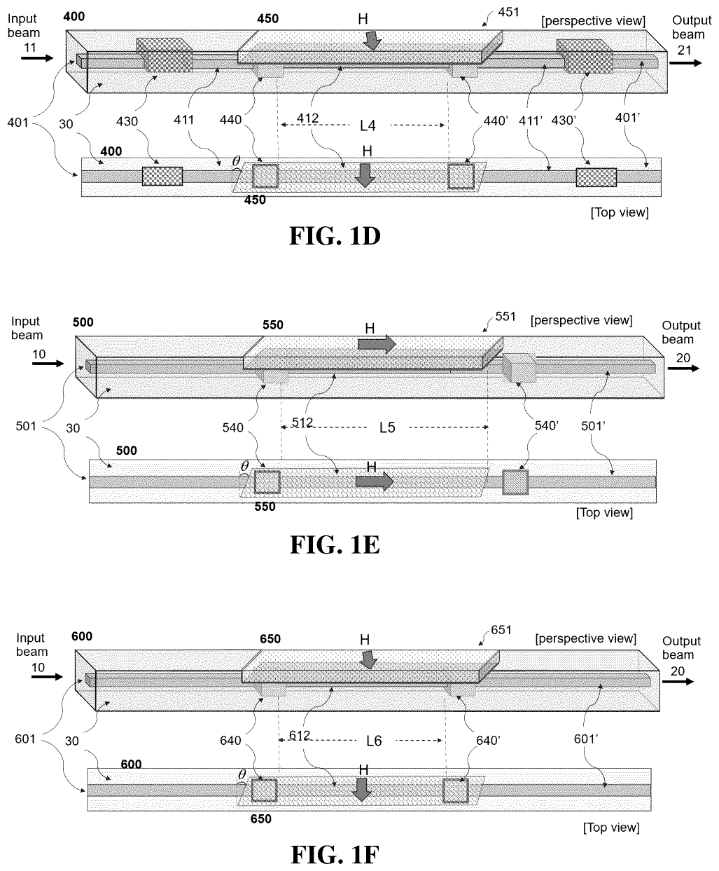

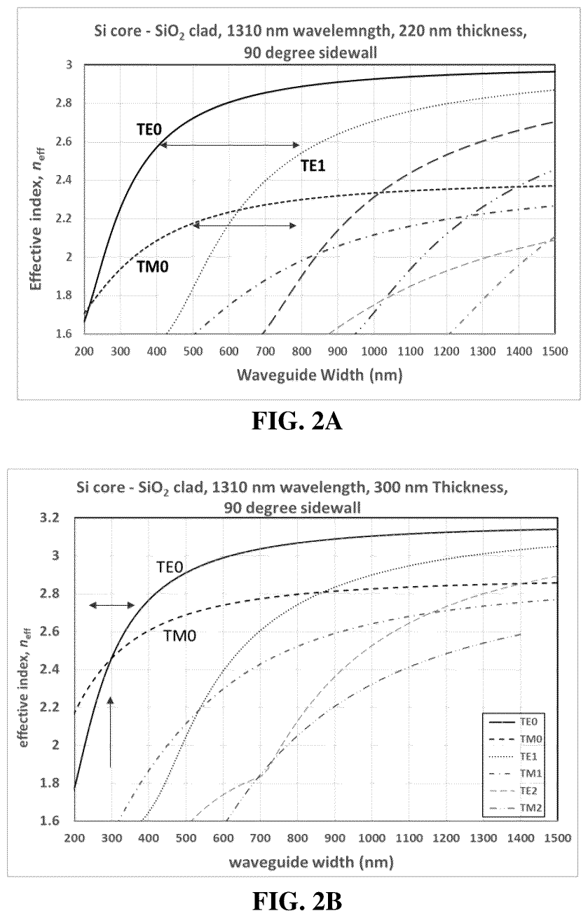

In FIGS. 1A to 2B, the polarization-mode controlled nonreciprocal optical waveguide device in this embodiment includes an optical waveguide (located in the core) with a relatively high refractive index through which an optical signal passes. It also has a clad with a relatively low refractive index surrounding the optical waveguide, and a magneto-optical thin film clad made of a magneto-optical material with a relatively low refractive index on one side of the optical waveguide. There is a waveguide-mode converter to set the polarization mode of optical signals for low optical loss in the MO-clad waveguide region before entering from the non-MO-clad waveguide region. Additionally, there is a polarization-mode converter to set the polarization mode of the optical signal entered in the MO-clad waveguide region and placed in the input side of the MO-clad region for maximum MO effect generation. Finally, there is another polarization-mode converter placed at the output side of the MO-clad region to set the polarization mode of the optical signal for low optical loss at the interface between the MO-clad and the non-MO-clad regions.

The optical waveguide can be made of materials, such as Si, SiN, SiO2, InP, GaAs, and Ge. It is crucial for the material to have minimal optical loss at the wavelength being used and to be easily integrated with other optical devices. Additionally, the magneto-optical thin film material should have high optical transmittance and a considerable Faraday rotation value within the wavelength band being utilized. For instance, materials like Bi:YIG, Ce:YIG, Pr,Bi:YIG, Bi,Tb:FeGaO, Bi,Nd:FeO, Ce:TbFeO, Dy:CeFeO, and others can be utilized. When applying the magneto-optical thin film directly onto the silicon surface, a buffer layer of YIG, MgO, or other suitable materials can be applied beforehand to alleviate the lattice mismatch between the Si surface and the MO film. If the magneto-optical thin film itself has high remanent magnetization, it can be utilized without a separate external magnetic field. Alternatively, if the magneto-optical thin film has low remanent magnetization, a magnetic thin film can be formed on top of it.

Materials like SmCo, SmCoCuFeZr, NdFeB/Nb, FeCo, or CoPt can be utilized as an example of the magnetic thin film.

Hereinafter, the structure of various embodiments of the polarization-mode controlled nonreciprocal optical waveguide device is described in detail about each drawing.

FIGS. 1A-1F illustrate a nonreciprocal optical waveguide device with polarization-mode control, as described in the first embodiment of the invention. The device comprises a rectangular semiconductor or dielectric optical waveguide with a magneto-optical thin film cladding on one side. This configuration maximizes the magneto-optical effect and minimizes optical loss based on the polarization of the incoming optical signal.

FIG. 1A shows a perspective view and a plan view, respectively, of a polarization-mode controlled nonreciprocal optical waveguide element 100 according to the present invention. It consists of a low-height optical waveguide (101) (less than 250 nm in the case of a silicon optical waveguide) (located in the core) wrapped with a low-refractive-index clad (30) for an incident input light 10 of TE0 fundamental polarization mode. As shown in FIG. 2A, the incident TE0-mode light is converted to TE1 mode while passing through the first waveguide mode conversion section 110 (a waveguide mode converter, the same applies hereinafter), which widens the width of the optical core waveguide by using the same effective refractive index of the optical waveguide width. The converted beam enters the waveguide 111 and then passes through section 150 where a magneto-optical thin film clad (151) covers the top of the waveguide. It is immediately converted again to TM0 mode while passing through the first polarization-mode conversion section 120 (an input-side polarization converter; the same applies hereinafter). This section has a polarization rotator structure that slightly reduces the waveguide width by using the same effective refractive index of the optical waveguide width as shown in FIG. 2A.

When the boundary surface of section 250, covered with the magneto-optical thin film clad, is orthogonal to the optical waveguide 211, the propagating light ray experiences greater reflection and optical loss. To address this issue, the boundary surfaces of both sides of the magneto-optical thin film located at the top are tilted at a certain angle θ to the axis perpendicular to the optical waveguide propagation direction.

As the light ray passes through the length L1 of the optical waveguide 112 of section 150 covered with the magneto-optical thin film clad, a nonreciprocal phase shift occurs when the direction of the magnetic field H applied to the clad is perpendicular to the light propagation direction. Before the light passes through section 150 covered with the magneto-optical thin film clad, the second polarization-mode conversion section 120′ (the output side polarization converter, the same applies hereinafter) slightly widens the width of the optical waveguide 112 by using the same effective refractive index as shown in FIG. 2A. This changes the waveguide mode to TE1, and then the converted mode TE1 exits to the optical waveguide 111′, thereby reducing optical loss. The width of the optical waveguide 111′ is reduced again by using an optical waveguide width with the same effective refractive index as shown in FIG. 2A to change the waveguide mode of the light to TE0 through a second waveguide mode converter section 110′ (by the second waveguide mode converter, the same applies hereinafter). Finally, the light exits as 20 through the output optical waveguide 101′.

FIG. 1B shows a perspective view and a plan view, respectively, of a polarization-mode controlled nonreciprocal optical waveguide element 200 according to the present invention. This element consists of a low-height optical waveguide (201), with a height of less than 250 nm in the case of a silicon optical waveguide, wrapped with a low-refractive-index clad (30) for an incident input light 11 of TM0 fundamental polarization mode. As shown in FIG. 2A, the incident TM0-mode light is converted to TE1 mode while passing through the third waveguide-mode conversion section 210, which widens the width of the optical core waveguide by using the same effective refractive index of the optical waveguide width. The light enters the waveguide 211 and then passes through section 250, where a magneto-optical thin film clad (251) covers the upper part of the waveguide. It is immediately converted to TM0 mode while passing through the third polarization-mode conversion section 220. This section has a polarization rotator structure that slightly reduces the waveguide width by using the same effective refractive index of the optical waveguide width as shown in FIG. 2A or consists of a polarization rotator.

When the boundary surface of section 250, covered with the magneto-optical thin film clad, is orthogonal to the optical waveguide 211, the propagating light ray experiences greater reflection and optical loss. To address this issue, both sides of the magneto-optical thin film's boundary surfaces at the top are tilted at a certain angle θ to the axis perpendicular to the optical waveguide propagation direction.

As the light ray passes through the length L2 of the optical waveguide 212 of section 150 covered with the magneto-optical thin film clad, a nonreciprocal phase shift occurs when the direction of the magnetic field H applied to the clad is perpendicular to the light propagation direction. Before the light passes through section 250, covered with the magneto-optical thin film clad, the fourth polarization-mode conversion section 220′ slightly widens the width of the optical waveguide 212 by using the same effective refractive index as shown in FIG. 2A. This changes the waveguide mode to TE1, and then the converted mode TE1 exits to the optical waveguide 211′, thereby reducing optical loss. The width of the optical waveguide 211′ is reduced again by using an optical waveguide width with the same effective refractive index as shown in FIG. 2A to change the waveguide mode of the light to TE0 through the fourth waveguide-mode converter section 210. Finally, the light exits as 20 through the output optical waveguide 201′.

FIG. 1C shows a perspective view and a plan view, respectively, of a polarization-mode controlled nonreciprocal optical waveguide element 300 according to the present invention. This component consists of a high-height optical waveguide (301) (equal to and greater than 250 nm in the case of a silicon optical waveguide) wrapped with a low-refractive-index clad (30) for an incident input light 11 of TM0 fundamental polarization mode. As shown in FIG. 2B, the incident TM0-mode light is converted to TE0 mode while passing through the fifth polarization-mode conversion section 330 which widens the width of the optical core waveguide by using the same effective refractive index of the optical waveguide width. The converted beam enters the waveguide 311 and then passes through section 350 where a magneto-optical thin film clad (351) covers the upper part of the waveguide. It is immediately converted to TM0 mode while passing through the sixth polarization-mode conversion section 340 of the polarization rotator structure that slightly reduces the waveguide width by using the same effective refractive index of the optical waveguide width as shown in FIG. 2B or consists of a polarization rotator.

When the boundary surface of section 350, covered with the magneto-optical thin film clad, is orthogonal to the optical waveguide 311, the propagating light ray experiences greater reflection and optical loss. To address this issue, both sides of the magneto-optical thin film's boundary surfaces at the top are tilted at a certain angle θ to the axis perpendicular to the optical waveguide propagation direction.

As the light ray passes through the length L3 of the optical waveguide 312 of section 350 covered with the magneto-optical thin film clad, a nonreciprocal polarization rotation occurs when the direction of the magnetic field H applied to the clad is parallel to the light propagation direction. The length L3 of the optical waveguide 312 is selected based on the Faraday coefficient of the magneto-optical thin film clad (351) and the magnitude of the applied magnetic field so that the polarization rotation occurs only 45 degrees. At the same time, the light passes through the optical waveguide 312. The optical waveguide 312 of section 350, covered with the magneto-optical thin film clad, is configured with a waveguide width in which the effective refractive indices of TE0 and TM0 are the same or a structure capable of phase matching between these two polarization modes. The light passes through section 350, covered with the magneto-optical thin film. Then, it emerges as the output light 21 through the output optical waveguide 301′ configured with a width optimized for a single polarization so that polarization rotation does not occur.

FIG. 1D shows a configuration (structure) where a nonreciprocal phase shift occurs instead of a nonreciprocal polarization rotation in the above FIG. 1C when a magnetic field is applied perpendicular to the direction of light propagation over the section 450, which is covered with the magneto-optical thin film clad. As the light passes through the optical waveguide 412 of the length L4 of section 450 covered with the magneto-optical thin film clad, the size of the nonreciprocal phase shift is determined by the Faraday coefficient of the magneto-optical thin film clad (451) and the magnitude of the applied magnetic field. Before the light passes through section 450, covered with the magneto-optical thin film, it goes through the sixth polarization-mode conversion section 440′ to rotate the polarization of the waveguide mode by 90 degrees. Then, it exits through the optical waveguide 411′ to reduce optical loss. Finally, through the fifth waveguide-mode conversion section 430′, the optical waveguide mode is changed to TE0 and output as the output light 21 through the output optical waveguide.

FIG. 1E shows a perspective view and a plan view, respectively, of a polarization-mode controlled nonreciprocal optical waveguide element 500 according to the present invention. This element consists of a high-height optical waveguide (501) (250 nm or thicker in the case of a silicon optical waveguide) wrapped with a low-refractive index clad (30) for an incident input light 10 of TE0 fundamental polarization mode. Once the light enters section 550, covered with the magneto-optical thin film clad (551) along the optical waveguide (501), the light's polarization mode is immediately converted to the TM0 mode while passing through the seventh polarization-mode conversion section 540.

When the boundary surface of section 250, covered with the magneto-optical thin film clad, is orthogonal to the optical waveguide 501, the propagating light ray experiences greater reflection and optical loss. To address this issue, both sides of the magneto-optical thin film's boundary surfaces at the top are tilted at a certain angle θ to the axis perpendicular to the optical waveguide propagation direction.

As the light beam passes through the optical waveguide 512 of the length L5 of section 550 covered with the magneto-optical thin film cladding, nonreciprocal polarization rotation occurs when the direction of the magnetic field H applied to this section is the same as the light propagation. The length L5 of the optical waveguide 512 is selected based on the Faraday coefficient of the magneto-optical thin film cladding (551) and the magnitude of the applied magnetic field H, so the polarization rotation occurs only 45 degrees. At the same time, the light passes through the optical waveguide 512. The optical waveguide 512 of section 550, covered with the magneto-optical thin film cladding, is configured with a waveguide width in which the effective refractive indices of TE0 and TM0 are the same or with a structure in which phase matching between these two polarization modes is possible. The structure is configured such that when the light passes through section 550 covered with the magneto-optical thin film clad, polarization is rotated 90 degrees through polarization converter 540′ and then output as the output light 20 through the output optical waveguide 501′.

FIG. 1F is a configuration in which nonreciprocal phase shift occurs instead of nonreciprocal polarization rotation as in the above FIG. 1E when a magnetic field H is applied perpendicular to the direction of light propagation in section 650 covered with the magneto-optical thin film clad. As the light passes through the optical waveguide 612′ of the length L6 of the section 650 covered with the magneto-optical thin film clad, the magnitude of the nonreciprocal phase shift is determined according to the Faraday coefficient of the magneto-optical thin film clad (651) and the magnitude of the applied magnetic field. Before the light passes through the section 650 covered with the magneto-optical thin film clad, it goes through the seventh polarization-mode conversion section 440′ to rotate the polarization of the waveguide mode by 90 degrees. It then exits through the optical waveguide 601′, reducing optical loss, and is output as the output light 20 through the output optical waveguide 601′.

FIGS. 2A and 2B show examples of calculated effective refractive indices of waveguide modes plotted as functions of the waveguide width when the height of the silicon optical waveguide covered with SiO₂ clad is 220 nm and 300 nm, respectively. When the height of the silicon optical waveguide is 220 nm as shown in FIG. 2A, the waveguide width, where the effective refractive indices of the fundamental waveguide modes (TE0 mode and TM0 mode) are the same, is too narrow. This narrow waveguide results in very large optical propagation loss, rendering it useless. However, the different waveguide widths for the TE0 mode and TE1 mode with the same effective refractive index allow for mode conversion between the two modes by changing the waveguide width. Additionally, when the waveguide width is approximately 620 nm, the effective refractive indices of the TE1 and TM0 modes are almost the same, enabling conversion of the TE1 mode to the TM0 mode by adjusting the waveguide width slightly from a little wider width to a little narrower width than 620 nm. In FIG. 2B, with a silicon waveguide height of 300 nm, the effective refractive indices of the TE0 mode and TM0 mode are the same at a relatively larger waveguide width of around 300 nm, allowing for mode conversion between the TE0 and TM0 modes by adjusting the waveguide between the narrower and wider widths around 300 nm.

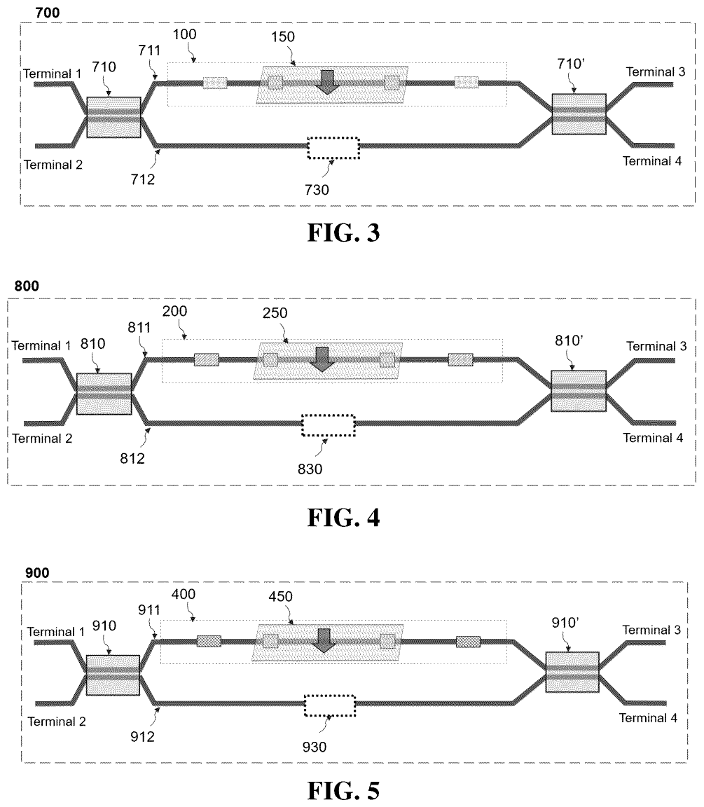

FIG. 3 shows a Mach-Zehnder interferometer-type optical isolator structure 700 designed for TE0 mode input optical signals according to one embodiment of the present invention. This structure consists of planar optical waveguides with a low height (less than 250 nm in the case of a silicon optical waveguide). It comprises two 2×2 or 1×2 optical couplers 710 and 710′, connected by two optical waveguide arms 711 and 712. A polarization-mode controlled nonreciprocal optical waveguide element 100 of FIG. 1A is placed on one arm, and a reciprocal phase shifter 730 is placed on the other arm. This optical isolator structure utilizes the interference peak wavelength changes due to the nonreciprocal phase shift between optical signals propagating in different directions.

FIG. 4 is one embodiment of the present invention showing a Mach-Zehnder interferometer-type optical isolator structure 800 designed for TM0 mode input optical signals instead of the TE0 mode input optical signals shown in FIG. 3. This structure is made up of planar optical waveguides having a low height (thinner than 250 nm in the case of a silicon optical waveguide) and a suitable waveguide width for the TM0 mode propagation. It comprises 2×2 or 1×2 optical couplers 810 and 810′, as well as two optical waveguide arms 811 and 812 that connect them. A polarization-mode controlled nonreciprocal optical waveguide element 200 of FIG. 1B is positioned on one arm, while a reciprocal phase shifter 830 is placed on the other arm. This optical isolator structure takes advantage of the interference peak wavelength change resulting from the nonreciprocal phase shift between optical signals propagating in one direction and those propagating in the opposite direction.

FIG. 5 is another embodiment of the present invention showing a Mach-Zehnder interferometer-type optical isolator structure 900 designed for a TM0 mode input optical signal. This structure is made up of planar optical waveguides having a high height (equal to and greater than 250 nm in the case of a silicon optical waveguide) and a suitable waveguide width for the TM0 mode propagation. It consists of two 2×2 or 1×2 optical couplers 910 and 910′ and two optical waveguide arms 911 and 912 connecting them. A polarization-mode controlled nonreciprocal optical waveguide element 400 as shown in FIG. 1D is placed on one arm, and a reciprocal phase shifter 930 is placed on the other arm. This optical isolator structure utilizes the characteristic where the interference peak wavelength changes due to the nonreciprocal phase shift between optical signals propagating in one direction and optical signals propagating in the opposite direction.

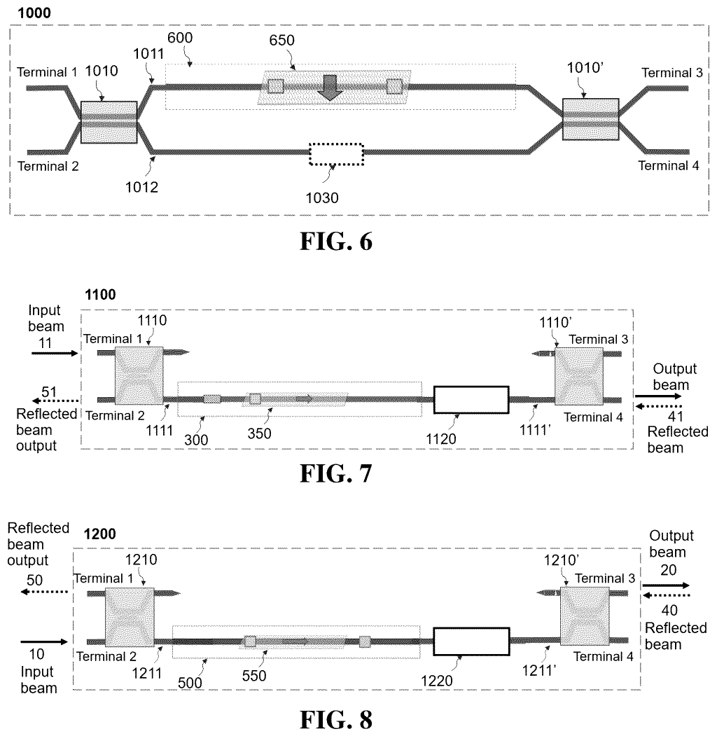

FIG. 6 is another embodiment of the present invention showing a Mach-Zehnder interferometer-type optical isolator structure 1000 designed for TE0 mode input optical signals instead of the TM0 mode input optical signals shown in FIG. 5. This structure is made up of planar optical waveguides having a high height (equal to and above 250 nm in the case of a silicon optical waveguide) and a suitable waveguide width for the TE0 mode propagation. It consists of two 2×2 or 1×2 optical couplers 1010 and 1010′, as well as two optical waveguide arms 1011 and 1012 connecting them. A polarization-mode controlled nonreciprocal optical waveguide element 600 of FIG. 1F is placed on one arm, while a reciprocal phase shifter 1030 is placed on the other arm. This optical isolator structure takes advantage of the property where the interference peak wavelength changes due to the nonreciprocal phase shift between optical signals propagating in one direction and optical signals propagating in the opposite direction.

FIG. 7 is another embodiment of the present invention showing an optical isolator structure 1100 designed for TM0 mode input optical signal. It is made up of planar optical waveguides having a high height (equal to and above 250 nm in the case of a silicon optical waveguide) and an appropriate waveguide width for the TM0 mode propagation. The structure consists of two 2×2 or 1×2 optical coupler-type polarization beam splitters 1110 and 1110′ and one optical waveguide arm 1111-1111′ connecting them. Along this arm, a 45-degree nonreciprocal polarization rotator form by a polarization-mode controlled nonreciprocal optical waveguide element 300 of FIG. 1C and a reciprocal 45-degree polarization rotator 1120 are placed. An input TM0 beam 11 entering through terminal 1 is converted to a TE0-mode beam and output to terminal 4. A reflected beam of TM0 mode entering through terminal 4 propagates across the terminal of the polarization beam splitter 1110′ and disappears. A reflected beam of TE0 mode entering through terminal 4 propagates in the reversed direction without any polarization change through terminal 2 on the input side. This isolator uses the different optical paths between forward and backward optical beams.

FIG. 8 shows an optical isolator structure 1200 for TE0 mode input optical signal instead of the TM0 mode optical signal input in FIG. 7. This structure is made up of planar optical waveguides having a high height (equal to and above 250 nm in the case of a silicon optical waveguide) and a suitable waveguide width for the TE0 mode propagation. It comprises two 2×2 optical coupler-type polarization beam splitters 1210 and 1210′ and one optical waveguide arm 1211-1211′ connecting them. Along this arm, a 45-degree nonreciprocal polarization rotator is formed by a polarization-mode controlled nonreciprocal optical waveguide element 500 of FIG. 1E and a reciprocal 45-degree polarization rotator 1220. An input TE0 beam 10 entering through terminal 2 is converted to a TM0-mode beam and output to terminal 3. A reflected beam of TE0 mode entering through terminal 3 propagates through terminal of the polarization beam splitter 1210′ and disappears. A reflected beam of TM0 mode entering through terminal 3 propagates crossed terminal of the polarization beam splitter 1210′ in the reversed direction without any polarization change through terminal 1 on the input side. This isolator uses the different optical paths between forward and backward optical beams.

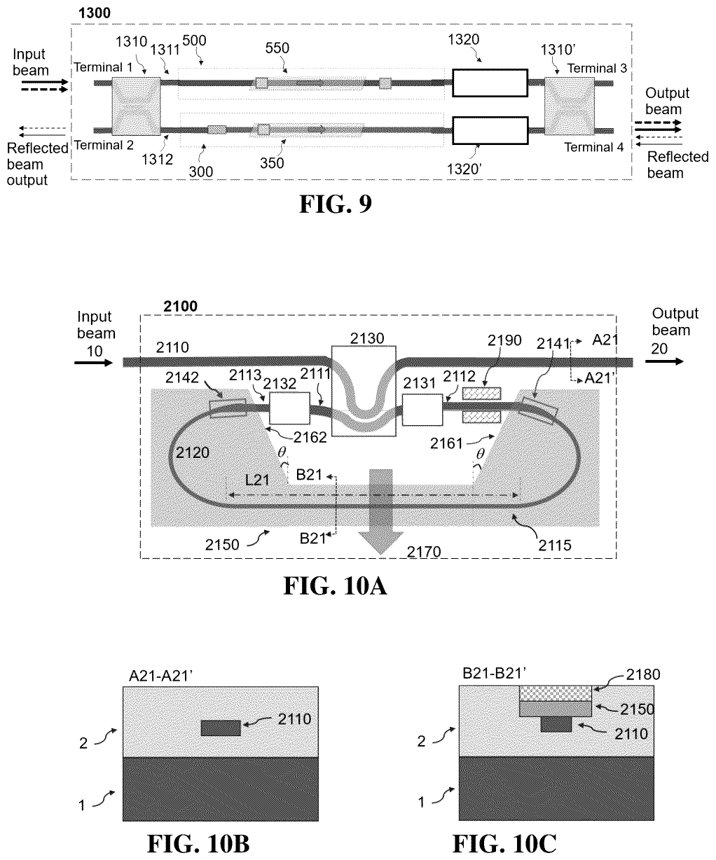

FIG. 9 depicts one embodiment of the present invention, which illustrates a polarization-independent optical isolator and circulator structure 1300. This structure is comprised of planar optical waveguides having a high height (equal to and above 250 nm in the case of a silicon optical waveguide) and an appropriate waveguide width for the TE0 and TM0 mode propagation. The optical isolator and circulator structure consists of two 2×2 optical coupler-type polarization beam splitters 1310 and 1310′ and two optical waveguide arms 1311 and 1312 connecting them. On the one optical waveguide arm 1311, a 45-degree nonreciprocal polarization rotator is formed by the polarization-mode controlled nonreciprocal optical waveguide element 500 of FIG. 1E and a reciprocal 45-degree polarization rotator 1320 is placed. On the other arm 1312, a 45-degree nonreciprocal polarization rotator formed by a polarization-mode controlled nonreciprocal optical waveguide element 300 of FIG. 1C and a reciprocal 45-degree polarization rotator 1320′ are placed. An input beam entering through terminal 1 to the polarization beam splitter 1310 is split into a TE0 polarization beam at the output optical path 1311 and a TM0 polarization beam at the output optical path 1312. The TE0 polarization-mode beam traveling along the optical path 1311 is converted into TM0 polarization mode during the passage through the 45-degree nonreciprocal polarization rotator 500 and the reversible 45-degree polarization rotator 1320, and then travels in a cross direction through the polarization beam splitter 1310′ and is output to terminal 4. The TM0 polarization-mode beam traveling along the optical path 1312 is converted into TE0 polarization mode during the passage through the 45-degree nonreciprocal polarization rotator 300 and the reversible 45-degree polarization rotator 1320′ and then travels straight through the polarization beam splitter 1310′ and is output to terminal 4. Regardless of the input polarization mode, a light beam input to terminal 1 is output to the terminal 4. On the other hand, an optical beam reflected back to terminal 4 passes through the polarization beam splitter 1310′. Then, the split TE0 polarization-mode beam by the polarization beam splitter 1310′ propagates in a straight line along optical path 1312 while the split TM0 polarization-mode beam propagates in a cross direction along optical path 1311. The polarization modes of the light beam traveling in opposite directions along the two paths arrive at the polarization beam splitter 1310 without polarization rotation because the polarization rotations of the reciprocal polarization rotator and the nonreciprocal polarization rotator cancel each other out. The TM0 polarization-mode beam returning to optical path 1311 travels in a cross direction through the polarization beam splitter 1310 and is output to terminal 2, and the TE0 polarization-mode beam returning to optical path 1312 travels straight through the polarization beam splitter 1310 and is output to terminal 2. Therefore, element 1300 functions as an optical isolator for which the input beam travels from terminal 1 to terminal 4 but does not return. Additionally, since the beam incident on terminal 4 is output to terminal 2, its function behaves as an optical circulator.

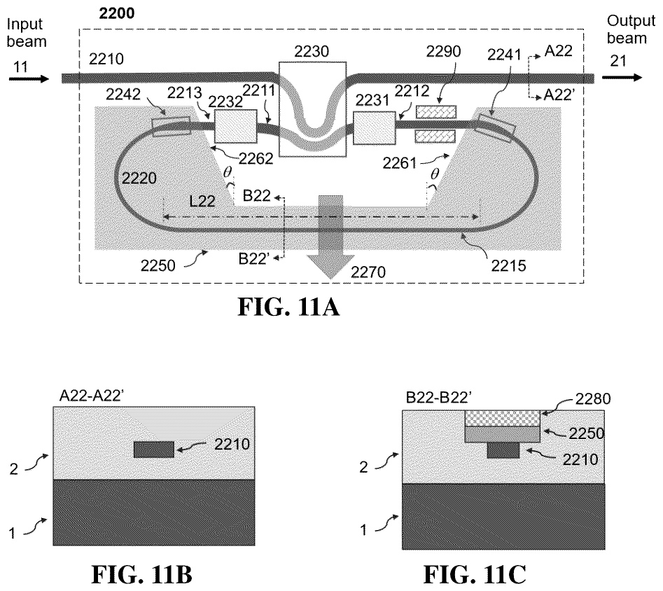

FIG. 10A shows a plan view of a ring-shaped optical isolator structure 2100 for an optical signal of the TE0 fundamental polarization mode according to the present invention. It consists of a straight planar optical waveguide 2110 and a ring-shaped optical waveguide 2120 with optical waveguides of low height (less than 250 nm in the case of a silicon optical waveguide). A TE0 fundamental polarization-mode optical signal 10 is incident on the optical waveguide 2110 and coupled to the ring 2120 by the optical coupler 2130. The optical signal passes through the waveguide mode converter 2131, which widens the width of the optical core waveguide by using the same effective refractive index as shown in FIG. 2A, and the incident TE0 mode light is converted to TE1 mode. Then, the converted TE1 mode beam enters the optical waveguide section 2150 covered with a magneto-optical thin film clad along the waveguide 2112 and is immediately converted to a TM0 polarization-mode beam by the polarization mode converter 2141. The TM0 polarization-mode beam undergoes a nonreciprocal phase shift as it passes through the straight optical waveguide section 2115 and is converted back to the TE1 polarization-mode beam by the polarization mode converter 2142 before exiting the optical waveguide section 2150 covered with the magneto-optical thin film clad. The TE1 polarization-mode beam emerges from the optical waveguide section 2150 covered with the magneto-optical thin film clad and proceeds into the optical waveguide 2113. Then, it is converted to the original TE0 polarization-mode beam by the waveguide mode converter 2132 during its propagation. The optical waveguide width 2111 is determined to be a size that has a good coupling effect at the optical coupler 2130. The TE0 polarization-mode beam passes through the optical coupler 2130 and is outputted to the output beam 20.

To control the resonance wavelength of the ring and to compensate for and control changes in the resonance wavelength caused by temperature changes or environmental changes, several methods are employed: (1) a heating electrode 2190 is formed on the side of the ring optical waveguide, (2) a phase change material is formed as a local clad to change the phase, or (3) a local refractive index change process of the optical waveguide or clad is performed using illumination of a laser beam, ion beam, or ultraviolet ray beam, etc.

If the interface of the magneto-optical thin film cladding placed on the optical waveguides 2112 and 2113 is formed vertically to the waveguide propagation direction, it may cause a light reflection problem. Thus, the MO film interface is formed at an inclined angle θ to the vertical direction.

The arrow labeled 2170 in the diagram shows the direction of the magnetic field applied to the magneto-optical thin film cladding, which is perpendicular to the direction of the optical signal propagation along the optical waveguide. FIGS. 10B and 10C show the cross-section A21-A21′ of the basic optical waveguides and the cross-section B21-B21′ of the waveguide section covered with the magneto-optical thin film clad as shown in FIG. 10A, respectively.

An optical waveguide core 2110 with a high refractive index is formed in a dielectric clad 2 with a relatively low refractive index located on the substrate 1. The waveguide section covered with the magneto-optical thin film cladding shows the cross-section of the optical waveguide core 2110 having a magneto-optical clad thin film 2150 formed on top. When the remanent magnetization of the magneto-optical thin film is non-existent or low, a magnetic thin film 2180 is formed on top. This structure is an optical isolator that utilizes the characteristic that the resonance peak wavelength changes due to the nonreciprocal phase shift between the TE0 optical beam propagated in the direction of input light 10 to the optical isolator 2100 and the optical beams propagated in the opposite direction.

FIG. 11A shows a plan view of a ring-shaped optical isolator structure for an optical signal of the TM0 polarization mode instead of the TE0 mode of FIG. 10A, which utilizes the polarization-mode controlled nonreciprocal optical waveguide element and consists of optical waveguides with a low height (less than 250 nm in the case of a silicon optical waveguide). A TM0 fundamental polarization-mode optical signal 11 is incident on the straight optical waveguide 2210 and coupled to the ring 2220 by the optical coupler 2230. The optical signal passes through the waveguide mode converter 2231, which widens the width of the optical core waveguide by using the same effective refractive index as shown in FIG. 2A, and the incident TM0 mode light is converted to TE1 mode. Then, the converted TE1 mode beam enters the optical waveguide section 2250 covered with a magneto-optical thin film clad along the waveguide 2212 and is immediately converted to a TM0 polarization-mode beam by the polarization mode converter 2241. The TM0 polarization-mode beam undergoes a nonreciprocal phase shift as it passes through the straight optical waveguide section 2215, and is converted back to the TE1 polarization-mode beam by the polarization mode converter 2242 before exiting the optical waveguide section 2250 covered with the magneto-optical thin film clad. The TE1 polarization-mode beam emerges from the optical waveguide section 2150 covered with the magneto-optical thin film clad and proceeds into the optical waveguide 2213. Then, it is converted to the original TM0 polarization-mode beam by the waveguide mode converter 2232 during its propagation. The optical waveguide width 2211 is determined to be a size that has a good coupling effect at the optical coupler 2230. The TM0 polarization-mode beam passes through the optical coupler 2230 and is outputted to the output beam 21. To control the resonance wavelength of the ring and to compensate for and control changes in the resonance wavelength caused by temperature changes or environmental changes, (1) a heating electrode 2290 is formed on the side of the ring optical waveguide, (2) a phase change material is formed as a local clad to change the phase, or (3) a local refractive index change process of the optical waveguide or clad is performed using illumination of a laser beam, ion beam, or ultraviolet ray beam, etc. If the interface of the magneto-optical thin film cladding placed on the optical waveguides 2212 and 2213 is formed vertically, it may cause a light reflection problem. Thus, the MO film interface is formed at an inclined angle θ to the vertical direction. The direction of the arrow 2270 in the drawing indicates the direction of the magnetic field applied to the magneto-optical thin film cladding in a perpendicular direction of the optical signal propagation along the optical waveguide. FIGS. 11B and 11C show the cross-section A22-A22′ of the basic optical waveguides and the cross-section B22-B22′ of the waveguide section covered with the magneto-optical thin film clad as shown in FIG. 11A, respectively. An optical waveguide core 2210 having a high refractive index is formed in a dielectric clad 2 having a relatively low refractive index located on the substrate 1. The waveguide section covered with the magneto-optical thin film clad shows the cross-section of the optical waveguide core 2210 having a magneto-optical clad thin film 2250 formed on it top, and when the remanent magnetization of the magneto-optical thin film is non-existent or low, a magnetic thin film 2280 is formed on top. This is an optical isolator structure that utilizes the characteristic that the resonance peak wavelength changes due to the nonreciprocal phase shift between the optical beam propagated in the direction of input light 11 to the optical isolator 2200 and the optical beams propagated in the opposite direction.

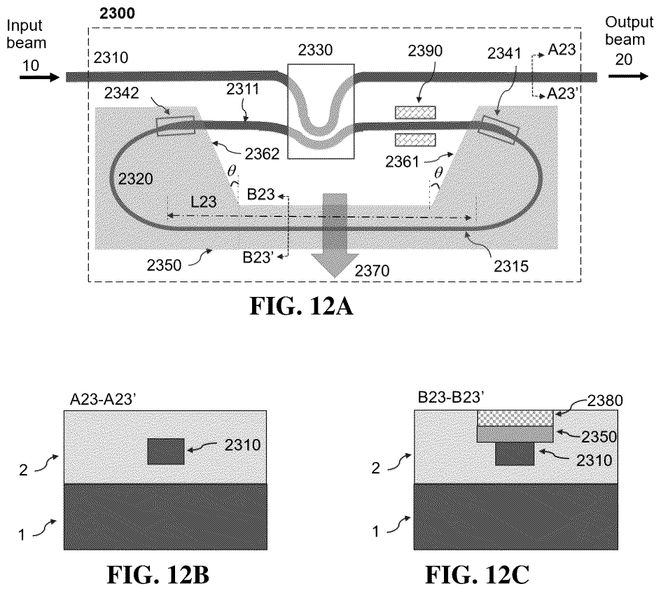

FIG. 12A shows a plan view of a ring-shaped optical isolator structure 2300 for an optical signal of the TE0 fundamental polarization mode according to the present invention. The structure is composed of a straight planar optical waveguide 2310 and a ring-shaped optical waveguide 2320, both of which are based on optical waveguides with high height (equal to and greater than 250 nm in the case of a silicon optical waveguide). A TE0 fundamental polarization-mode optical signal 10 enters the optical waveguide 2310 and coupled to the ring 2320 by the optical coupler 2330. The coupled beam enters the optical waveguide section 2350 covered with a magneto-optical thin film clad along the waveguide 2311 and is immediately converted to a TM0 polarization-mode beam by the polarization mode converter 2341. The TM0 polarization-mode beam undergoes a nonreciprocal phase shift as it passes through the straight optical waveguide section 2315, and is converted back to the TE0 polarization-mode beam by the polarization mode converter 2342 before exiting the optical waveguide section 2350 covered with the magneto-optical thin film clad. The TE0 polarization-mode beam emerges from the optical waveguide section 2350 and proceeds into the optical waveguide 2311. The optical waveguide width 2311 is determined to have a good coupling effect at the optical coupler 2330. The TE0 polarization-mode beam passes through the optical coupler 2330 and is outputted as the output beam 20. To control the resonance wavelength of the ring and to compensate for and control changes in the resonance wavelength caused by temperature changes or environmental changes, several methods can be used: (1) a heating electrode 2390 is formed on the side of the ring optical waveguide, (2) a phase change material is used as a local clad to change the phase, or (3) a local refractive index change process of the optical waveguide or clad is performed using illumination of a laser beam, ion beam, or ultraviolet ray beam, etc.

If the interface of the magneto-optical thin film cladding placed on the optical waveguide 2311 is formed vertically to the waveguide propagation direction, it may cause a light reflection problem. To avoid this, the MO film interface is formed at an inclined angle θ to the vertical direction. The direction of the arrow 2370 in the drawing indicates the direction of the magnetic field applied to the magneto-optical thin film cladding in a perpendicular direction of the optical signal propagation along the optical waveguide.

FIGS. 12B and 12C show the cross-section A23-A23′ of the basic optical waveguides and the cross-section B23-B23′ of the waveguide section covered with the magneto-optical thin film clad as shown in FIG. 12A, respectively.

An optical waveguide core 2310 with a high refractive index is formed in a dielectric clad 2 with a relatively low refractive index located on substrate 1. The waveguide section covered with the magneto-optical thin film clad shows the cross-section of the optical waveguide core 2310 having a magneto-optical clad thin film 2350 formed on its top. When the remanent magnetization of the magneto-optical thin film is non-existent or low, a magnetic thin film 2380 is formed on top.

This is an optical isolator structure that utilizes the characteristic that the resonance peak wavelength changes due to the nonreciprocal phase shift between the TE0 optical beam propagated in the direction of input light 10 to the optical isolator 2300 and the optical beams propagated in the opposite direction.

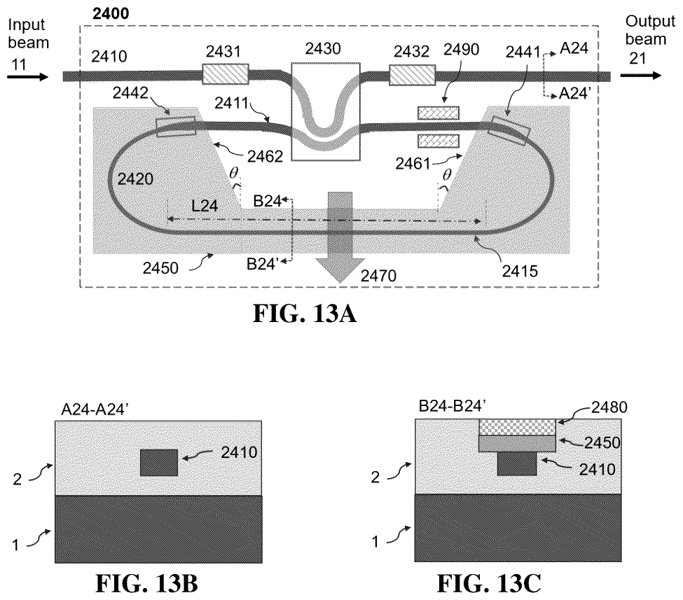

FIG. 13A shows a plan view of a ring-shaped optical isolator structure 2400 for an optical signal input of the TM0 polarization mode, instead of the TE0 mode of FIG. 12A. It uses a polarization-mode controlled nonreciprocal optical waveguide element and consists of optical waveguides with a high height (equal to and greater than 250 nm in the case of a silicon optical waveguide).

A TM0 fundamental polarization-mode optical signal 11 is incident on the straight optical waveguide 2410 and is converted to TE0 mode at the polarization-mode converter 2431. The converted TE0 mode beam is coupled to the ring 2420 by the optical coupler 2430. The optical beam travels along the optical waveguide 2411 and enters the optical waveguide section 2450 covered with a magneto-optical thin film clad. At the beginning of MO clad section, the optical beam is converted to a TM0 polarization mode during the passage through the polarization-mode converter 2441. The TM0 polarization-mode beam undergoes a nonreciprocal phase shift as it passes through the straight optical waveguide section 2415, and then is converted back to the TE0 polarization-mode beam by the polarization mode converter 2442 before exiting the optical waveguide section 2450 covered with the magneto-optical thin film clad. The TE0 polarization-mode beam emerges from the optical waveguide section 2450 and proceeds into the optical waveguide 2411. The width of the optical waveguide 2411 is chosen to facilitate good coupling at the optical coupler 2430. The TE0 polarization-mode beam passes through the optical coupler 2230 and is outputted as the output beam 21.

To control the resonance wavelength of the ring and to compensate for and control changes in the resonance wavelength caused by temperature changes or environmental changes, several methods can be employed: (1) a heating electrode 2490 is formed on the side of the ring optical waveguide, (2) a phase change material is formed as a local clad to change the phase, or (3) a local refractive index change process of the optical waveguide or clad is performed using illumination of a laser beam, ion beam, or ultraviolet ray beam, etc.

If the interface of the magneto-optical thin film cladding placed on the optical waveguide 2411 is formed vertically to the waveguide propagation direction, it may cause a light reflection problem. Thus, the MO film interface is formed at an inclined angle θ to the vertical direction. The direction of the arrow 2470 in the drawing indicates the direction of the magnetic field applied to the magneto-optical thin film cladding in a perpendicular direction of the optical signal propagation along the optical waveguide.

FIGS. 13B and 13C show the cross-section A24-A24′ of the basic optical waveguides and the cross-section B24-B24′ of the waveguide section covered with the magneto-optical thin film clad as shown in FIG. 13A, respectively. An optical waveguide core 2410 with a high refractive index is formed in a dielectric clad 2 with a relatively low refractive index located on the substrate 1. The waveguide section covered with the magneto-optical thin film clad shows the cross-section of the optical waveguide core 2410 with a magneto-optical clad thin film 2450 formed on top of it. When the remanent magnetization of the magneto-optical thin film is non-existent or low, a magnetic thin film 2480 is formed on top. This structure is an optical isolator that utilizes the characteristic that the resonance peak wavelength changes due to the nonreciprocal phase shift between the optical beam propagated in the direction of input light 11 to the optical isolator 2400 and the optical beams propagated in the opposite direction.

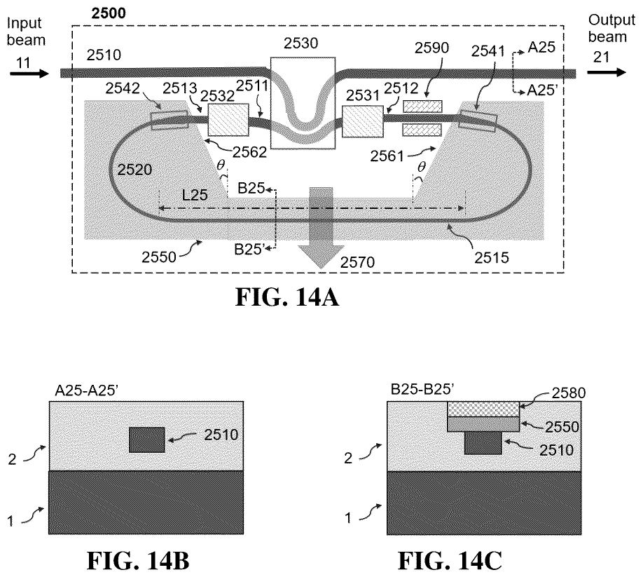

FIG. 14A shows a plan view of a ring-shaped optical isolator structure, according to another embodiment of the present invention for an optical signal input of the TM0 polarization mode. This structure utilizes the polarization-mode controlled nonreciprocal optical waveguide element and consists of optical waveguides with a high height (equal to and greater than 250 nm in the case of a silicon optical waveguide).

A TM0 fundamental polarization-mode optical signal 11 is incident on the straight optical waveguide 2510 and is coupled to the ring 2520 by the optical coupler 2530. The optical beam travels along the optical waveguide 2511 and is converted to TE0 mode at the polarization-mode converter 2531. The converted TE0 mode beam enters the optical waveguide section 2550 covered with a magneto-optical thin film clad. At the beginning of MO clad section, the optical beam is converted to a TM0 polarization mode during the passage through the polarization-mode converter 2541. The TM0 polarization-mode beam undergoes a nonreciprocal phase shift as it passes through the straight optical waveguide section 2515, and then is converted back to the TE0 polarization-mode beam by the polarization mode converter 2542 before exiting the optical waveguide section 2550 covered with the magneto-optical thin film clad. The TE0 polarization-mode beam emerges from the optical waveguide section 2550 and proceeds into the optical waveguide 2513. Then, the beam is converted into TM0 mode during the passage through the polarization-mode converter 2532 and travels along the optical waveguide 2511. The optical waveguide width 2511 is determined to have a good coupling effect at the optical coupler 2530. The TM0 polarization-mode beam passes through the optical coupler 2530 and is outputted to the output beam 21.

To control the resonance wavelength of the ring and to compensate for and control changes in the resonance wavelength caused by temperature changes or environmental changes, several methods can be employed: (1) a heating electrode 2590 is formed on the side of the ring optical waveguide, (2) a phase change material is formed as a local clad to change the phase, or (3) a local refractive index change process of the optical waveguide or clad is performed using illumination of a laser beam, ion beam, or ultraviolet ray beam, etc.

If the interface of the magneto-optical thin film cladding placed on the optical waveguides 2512 and 2513 is formed vertically to the waveguide propagation direction, it may cause a light reflection problem. Thus, the MO film interface is formed at an inclined angle θ to the vertical direction.

The direction of the arrow 2570 in the drawing indicates the direction of the magnetic field applied to the magneto-optical thin film cladding in a perpendicular direction of the optical signal propagation along the optical waveguide.

FIGS. 14B and 14C show the cross-section A25-A25′ of the basic optical waveguides and the cross-section B25-B25′ of the waveguide section covered with the magneto-optical thin film clad as shown in FIG. 14A, respectively. An optical waveguide core 2510 with a high refractive index is formed in a dielectric clad 2 with a relatively low refractive index located on the substrate 1. The waveguide section covered with the magneto-optical thin film clad shows the cross-section of the optical waveguide core 2510 having a magneto-optical clad thin film 2550 formed on top. When the remanent magnetization of the magneto-optical thin film is non-existent or low, a magnetic thin film 2580 is formed on top. This is an optical isolator structure that utilizes the characteristic that the resonance peak wavelength changes due to the nonreciprocal phase shift between the optical beam propagated in the direction of input light 11 to the optical isolator 2500 and the optical beams propagated in the opposite direction.

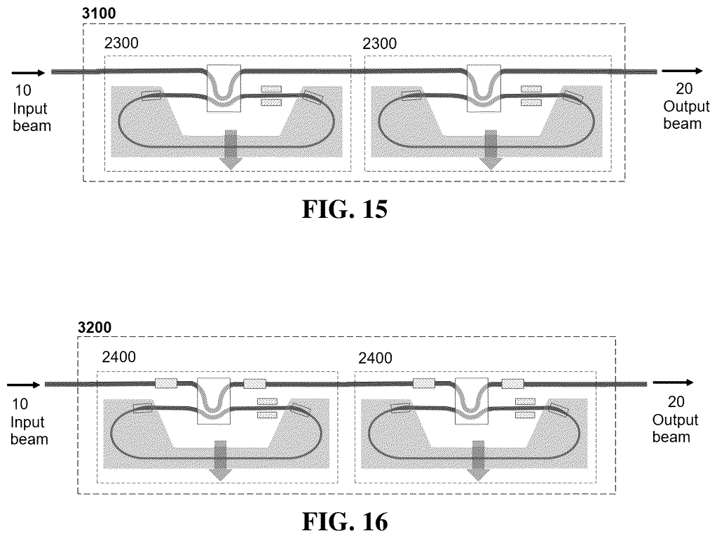

FIG. 15 shows a plan view of a ring-shaped optical isolator structure, according to one embodiment of the present invention, designed for an optical signal input of the TE0 polarization mode. This structure consists of optical waveguides with a high height (equal to and greater than 250 nm in the case of a silicon optical waveguide) and features a serially combined scheme of two ring-shaped optical isolator structures 2300 shown in FIG. 12A for the TE0 fundamental polarization-mode input to enlarge the cutoff resonant wavelength linewidth with a fine difference between the two rings. To further broaden the cutoff resonance wavelength linewidth by the same principle, a series connection of two or more ring-shaped resonators can be applied.

FIG. 16 shows a plan view of a ring-shaped optical isolator structure, according to one embodiment of the present invention, for an optical signal input of the TM0 polarization mode instead of the TE0 polarization mode shown in FIG. 15. This structure consists of optical waveguides with a high height (equal to and greater than 250 nm in the case of a silicon optical waveguide) and has a serially combined scheme of two ring-shaped optical isolator structures 2400 shown in FIG. 13A for the TM0 fundamental polarization-mode input. This design is intended to enlarge the cutoff resonant wavelength linewidth with a fine difference between the two rings. To further broaden the cutoff resonance wavelength linewidth, the same principle can be applied by connecting two or more ring-shaped resonators in series.

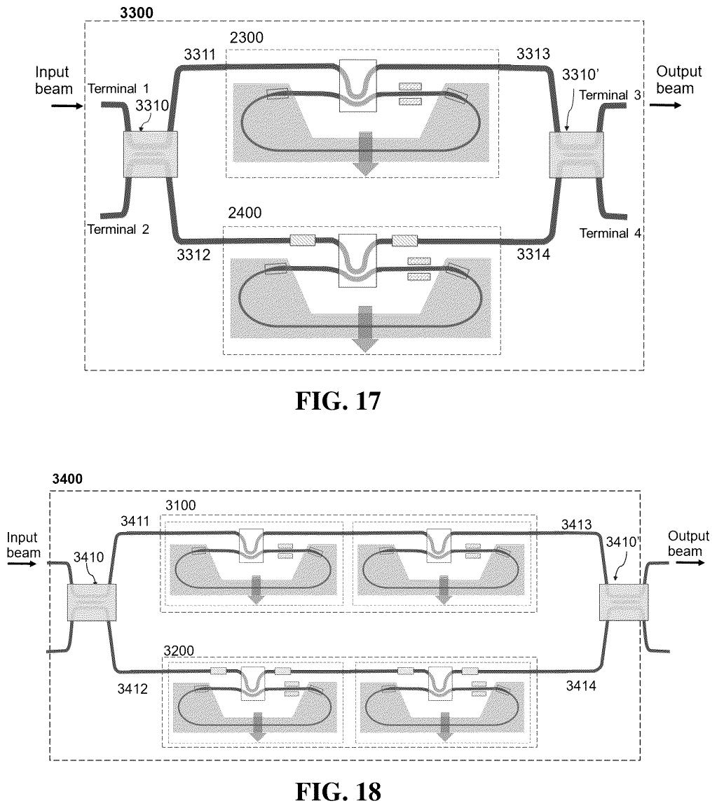

FIG. 17 illustrates a polarization-independent ring-shaped optical isolator structure 3300, according to one embodiment of the present invention, for an optical signal input of the TE0 and TM0 polarization modes. This structure consists of optical waveguides with a high height (equal to and greater than 250 nm in the case of a silicon optical waveguide). It employs a parallelly combined scheme of a ring-shaped optical isolator structure 2300 shown in FIG. 12A for the TE0 fundamental polarization-mode input and a ring-shaped optical isolator structure 2400 shown in FIG. 13A for the TM0 fundamental polarization-mode input, placed between two polarization beam splitters 3310 and 3310′. As depicted in FIG. 17, the TE0 component of the light incident through terminal 1 proceeds through the straight bar paths 3311 and 3313 of the polarizing beam splitter 3310 and is output to terminal 3 of the polarizing beam splitter 3310′, where optical isolation occurs by the TE0 ring-shaped optical isolator structure 2300 positioned on the path. Similarly, the TM0 component of the incident light proceeds through the cross paths 3312 and 3314 of the polarizing beam splitter 3310 and is output to terminal 3 of the polarizing beam splitter 3310′, where optical isolation occurs by the TM0 ring-shaped optical isolator structure 2400 positioned on the path.

FIG. 18 shows a polarization-independent ring-shaped optical isolator structure 3400. It operates on the same principle as the structure shown in FIG. 17, with the difference that it uses a pair of ring-shaped optical isolator structures 2300 in FIG. 12A for the TE0 fundamental polarization-mode input and a pair of ring-shaped optical isolator structures 2400 in FIG. 13A for the TM0 fundamental polarization-mode input. Two ring structures of each pair are connected in series. The pairs are used instead of using a single ring-shaped optical isolator structure for each of two arms connecting the two polarization beam splitters 3410 and 3410′ in the structure shown in FIG. 17. The serially connected pair of the ring-shaped optical isolator structures used on each polarization path have a slight difference in their ring sizes to enlarge the cutoff resonant wavelength linewidth compared to the case of using a single ring. To further broaden the cutoff resonance wavelength linewidth using the same principle, a scheme of connecting two or more ring-shaped resonators in series along each polarization path can be applied.

So far, the applicants have described various embodiments of the present invention. These embodiments are only examples that implement the technical idea of the present invention. However, any other embodiments, including changes or modifications to implement the technical idea of the present invention, should be interpreted as belonging to the scope of the present invention.

What is claimed is:

1. A polarization-mode controlled nonreciprocal optical waveguide device to control the polarization mode depending on the polarization of input optical signal comprising:
an optical waveguide of relatively high refractive index for optical signal transmission; cladding layers surrounding the above optical waveguide;
one side cladding layer of the above optical waveguide that is made of magneto-optic films with a relatively low refractive index;
a waveguide mode converter converting the waveguide mode based on the optical signal polarization that is positioned before the optical signal enters the waveguide section with the above magneto-optic film-clad layer to minimize optical loss,
an input side polarization-mode converter that maximizes the magneto-optic effect by converting the optical signal's polarization when it enters the waveguide section with the magneto-optic film-clad layer,
an output side polarization-mode converter that minimizes optical loss by converting the optical signal's polarization before it exits the waveguide section with the magneto-optic film-clad layer.

2. The polarization-mode controlled nonreciprocal optical waveguide device of claim 1 wherein
when the optical waveguide has a magneto-optic film-clad layer on its top and a low waveguide height,
the above waveguide mode converter converts the input TE0 or TM0 mode of the input signal into TE1 mode,
the above input side polarization-mode converter converts the TE1 mode into TM0 mode,
the above output side polarization-mode converter converts the TM0 mode back to TE1 mode.

3. The polarization-mode controlled nonreciprocal optical waveguide device of claim 1 wherein
when the optical waveguide has a magneto-optic film-clad layer on its top and a high waveguide height,
the above waveguide mode converter is eliminated for input optical signals of TE0 polarization mode,
the above input side polarization-mode converter converts the TE0 mode into TM0 mode,
the above output side polarization-mode converter converts the TM0 mode back to TE0 mode.

4. The polarization-mode controlled nonreciprocal optical waveguide device of claim 1 wherein
a second waveguide mode converter is positioned after the magneto-optic film-clad waveguide section to convert the waveguide mode of the optical signal output that emerges from the above polarization-mode converter on the output side as well as the waveguide section covered with the above magneto-optic film-clad layer, back into the waveguide mode of the original input signal.

5. A planar waveguide-type optical isolator comprising:
the polarization-mode controlled nonreciprocal optical waveguide device of claim 1 placed on one arm out of two arms, that connects a pair of 2×2 or 1×2 directional couplers, and is used as a nonreciprocal phase shifter with a magnetic field applied perpendicular to the beam propagation direction along the optical waveguide,
a reciprocal phase shifter that is placed on the other arm.

6. A planar waveguide-type optical isolator and optical circulator device comprising:
the polarization-mode controlled nonreciprocal optical waveguide device of claim 1 that is placed on one arm out of two arms connecting a pair of 2×2 or 1×2 coupler-type polarization beam splitters and is used as a nonreciprocal 45-degree polarization rotator with a magnetic field applied in a parallel direction to the beam propagation along the optical waveguide,
a reciprocal 45-degree polarization rotator that is placed next to the above nonreciprocal 45-degree polarization rotator on the same arm,
the other arm that is not connected to the above polarization beam splitters.

7. A polarization-independent planar waveguide-type optical isolator and optical circulator device operating independently on the polarization mode of input optical signals is composed of:
a pair of the polarization-mode controlled nonreciprocal optical waveguide devices of claim 1, each of that is used with a magnetic field applied in a parallel direction to the beam propagation along the optical waveguide for each of the input TE0 and TM0 polarization modes, respectively,
the above polarization-mode controlled nonreciprocal optical waveguide devices for the TE0 input polarization mode that is placed on one arm out of two arms connecting a pair of 2×2 or 1×2 coupler-type polarization beam splitters and is used as a nonreciprocal 45-degree polarization rotator with an additionally added reciprocal 45-degree polarization rotator in series,
the above polarization-mode controlled nonreciprocal optical waveguide devices for the TM0 input polarization mode that is placed on the other arm and is used as a nonreciprocal 45-degree polarization rotator with an additionally added reciprocal 45-degree polarization rotator in series.

8. A ring-type planar waveguide optical isolator comprising:
the polarization-mode controlled nonreciprocal optical waveguide device of claim 1 with a magnetic field applied in a perpendicular direction to the beam propagation along the optical waveguide that is used to compose a ring-type waveguide,
the above ring-type waveguide that has a waveguide portion covered with a clad whose refractive index can be easily changed under illumination of laser or ultraviolet light,
a linear optical waveguide that is coupled with the above ring-type optical waveguide.

9. A ring-type planar waveguide optical isolator comprising:
two or more ring-type planar waveguide optical isolators of claim 8 that are connected in serial to enlarge the resonant filtering wavelength linewidth.

10. A polarization-independent ring-type planar waveguide optical isolator operating independently on the polarization mode of input optical signals is composed of:
a pair of the polarization-mode controlled nonreciprocal optical waveguide devices of claim 1 with a magnetic field applied in a perpendicular direction to the beam propagation along the optical waveguide, each of that is used for input TE0 and TM0 polarization modes, respectively,
each of the above polarization-mode controlled nonreciprocal optical waveguide device pair that is used to form a ring-type waveguide,
each of the above ring-type waveguide that is coupled to a straight linear optical waveguide,
each of the above ring coupled straight linear optical waveguides that is formed as one of the ring-type planar waveguide optical isolators for TE0 and TM0 modes, respectively,
each of the above pair of ring-type planar waveguide optical isolators for TE0 and TM0 modes that is placed on each arm of the two arms formed between a pair of 2×2 polarization beam splitters, respectively.

11. A ring-type planar waveguide optical isolator of claim 10 wherein
two or more ring-type waveguides for each of the TE0 and TM0 polarization modes are connected in series and are placed on each arm of the two arms formed between the pair of polarization beam splitters.
